(19) United States
(12) Patent Application Publication
(10) Pub. No.: US 2007/0247965 A1
(43) Pub. Date: Oct. 25, 2007

(54) Visual Sizing of Particles

(76) Inventors: Constantijn Sanders, Sheffield (GB); Michael J. Hounslow, Sheffield (GB); Agba D. Salman, Sheffield (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/574,889

(22) PCT Filed: Sep. 8, 2005
(86) PCT No.: PCT/GB05/03479

§ 371 Date: Mar. 8, 2007

(30) Foreign Application Priority Data
Sep. 8, 2004 (GB) 0419914.7

(51) Int. Cl. G01N 15/14; B01J 2/12; G01N 1/10; G01N 1/20

(52) U.S. Cl. 366/143; 377/11

(57) ABSTRACT

A rotating disc extracts in a fan samples from a fluidized flow of particles in a container, for example a mixer. Each extracted sample overflies contrasting areas so that a camera images the fan. A programmed computer processor analyzes the images and produces size, shape, size distribution, and compositional information from the sample. The sample is representative of the flow as a whole.

This invention relates to a method of visually estimating the particle size and distribution of particles in turbulent mixture of the particles. The particles may be in a homogenous carrier fluid, or may be in vacuum. The invention finds particular application in the pharmaceutical industry, but also in many other industries, where, by a mixing/granulation process, ingredients are added together and result in a solid mixture in granular form for subsequent forming into tablets.

High shear granulation is one such process and Sanders et al^{[1]} analysed the different possible variables involved in the process. They produced a model of it and by which the results of the granulation process may be predicted. Nevertheless, it is desirable to monitor the granulation process in order to ensure the best results. However, interrupting it in order to take samples for particle size and distribution measurement (which is the single most important parameter that requires monitoring) is itself a variable that influences the final outcome. In any event, in many processes, such interruptions may not be permitted for health and safety reasons. Watano and Miyanami^{[2]} developed an on-line image processing method for a fluidised bed system that involves a probe disposed in the fluidised granular flow, the probe having an illuminator for the particles, a lens to image the light scattered by the particles near the probe, and a purge air flow to prevent particles impacting the probe and accumulating on the probe and blocking the lens. U.S. Pat. No. 5,497,232 relates to the apparatus and method of the system. Nevertheless, despite the purge air employed, it is an inherent problem with probes that they inevitably become clogged in time, particularly at early stages of mixing when there may be very wet and sticky particles that adhere to anything they touch. Further, any system that uses a stream of air to purge particles is likely also to cause some segregation in their size, resulting in a non-representative measurement of the size distribution.

DE-A-19645923 relates to a similar arrangement in which particles in the granulator drop into a collection chamber where an optical viewer analyses them. The problem of glogging would appear to be acute in this apparatus.

EP-A-391530 relates to a method of calculating particle sizes from an image of a pile of particles However, there is no “pile of particles” in an on-going granulation process.

JP-A-11304685 suggests aspiration of particles from a mixing chamber and adhering them to a film where optical analysis is effected. Thus a sample of the mixing products is extracted and analysed. Attempts merely to create a window in the mixture and optically analyse the products in the mixture fail because the contrast between the particles and, their background is inadequate to accurately distinguish them. Moreover, at a distance of over 30 cm and the fast aperture speed necessary to focus the particles, the depth of field is long enough to view too many of them, so that they become indistinguishable from one another. This explains the need to view just a sample, or to insert a probe which can view in a different direction than into the main body of the mixing particles.

There remains a need to provide a system which is not susceptible to clogging problems and which does not interfere with the mixing process.

In accordance with the present invention, there is provided an optical on-line sizing system for a flow path of particles, the system comprising:

an optical scanning system focussed on a field of view remote from said flow path;

a deflector to extract a representative sample of the particles from their flow path and distribute them in said field of view and whereby the size and size distribution of the particles in the flow path may be monitored; wherein

said deflector comprises a rotating disc disposed in said flow path and lying substantially in the plane of said field of view so that particles impacting the surface of the disc are deflected from said flow path into said field of view at different angles.

Preferably, said flow path is in a container provided with a window, said optical scanning system being outside said container.

Since the field of view is remote from the flow path, the problem of low contrast can be avoided. So also is the problem of excessive particle numbers. Hence, good definition can be had of most particles without the need for a long depth of focus.

Preferably, the edge of the disc is cylindrical, preferably circular cylindrical. On the other hand, the surface of the edge of the disc may be serrated to improve frictional engagement with particles impacting the edge.

Preferably, a top face of the disc is substantially planar and horizontal. Said top face may also be serrated to improve grip on particles landing on said face and being thrown from said face by centrifugal effects.

Preferably, said system also includes composition scanning means comprising a spectrometer. Moreover, moisture content and colour can also be monitored externally with cameras. For example cameras responsive to two different wavelengths, one of which is preferentially absorbed or reflected by moisture-containing particles.

The invention also provides a high shear mixer and particle size monitoring system, comprising:
a) a mixer having:
   i) a substantially cylindrical housing,
   ii) an impeller, mounted in the housing, which impeller, when driven, and when particles of mixture are sheared by the impeller, drives the particles in a toroidal flow path around the housing,
   iii) a rotary shaft extending through the housing,
   iv) a disc mounted on the end of the shaft so that the edge of the disc intercepts an inside edge of said toroidal flow path;
b) an optical scanner focussed on a field of view in a plane substantially parallel said disc between said toroidal flow path and the axis of the impeller; and
c) processing means to capture images of particle samples in said field of view deflected by said disc from said toroidal flow path and count and/or measure and/or determine the shape of said particles.

Preferably, said impeller is mounted in the base of said mixer. Said window may be in a top surface of the mixer.

Preferably, said shaft is substantially parallel said axis of the impeller. Preferably, up to about half the disc intercepts the flow path.

Preferably, said scanner and processing means are arranged to monitor particle constitution, for example, moisture content, and/or colour.

Preferably, light projecting means are provided. These are conveniently in the form of a bundle of optical fibers. The light projecting means may comprise a stroboscope. The light projecting means and optical scanner means may be affixed together as parts of a unitary photographic probe. In this case the probe may extend through the wall of the mixer.

However, the mixer may further comprise a window in the housing, said scanner being entirely external of the mixer. Said, window may be in a top surface of the mixer.

The mixer and system may further comprise control means for actuating the light projecting means and the optical scanner in timed synchronism with one another.

An embodiment of the invention is further described hereinafter, by way of example, with reference to the accompanying drawings, in which:

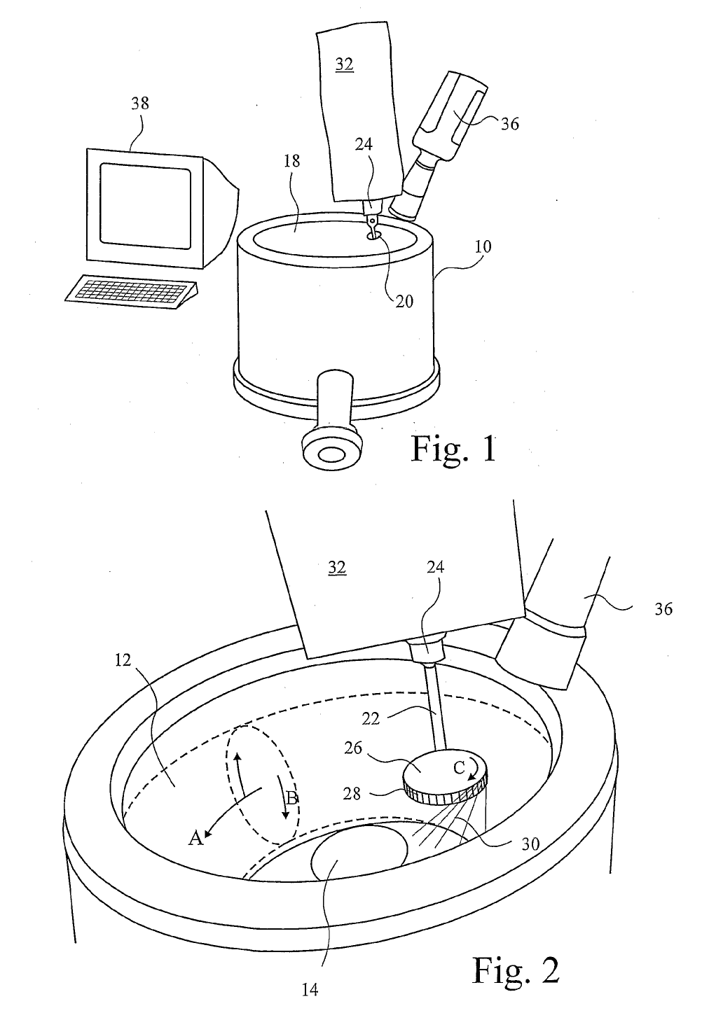

FIG. 1 is a perspective view of apparatus according to the present invention;

FIG. 2 is an internal view of a high shear mixer of the FIG. 1 arrangement, operating in accordance with the invention;

FIG. 3 is a plan view of the FIG. 2 arrangement;

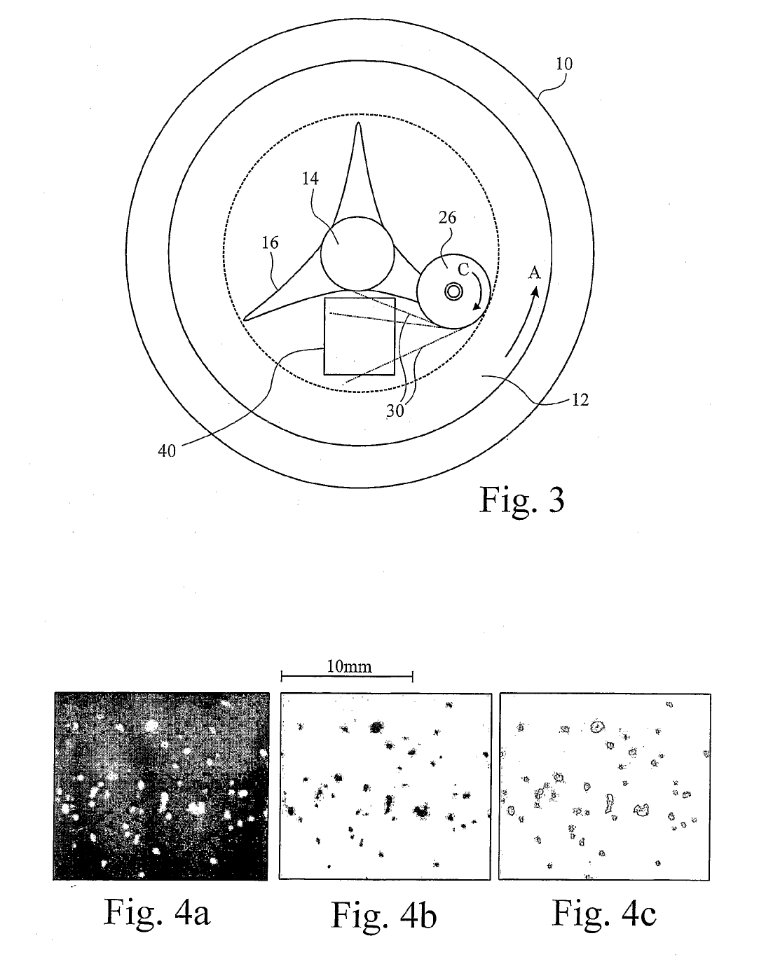

FIGS. 4a to c are different representations of the image captured by the camera of the FIG. 1 arrangement; and

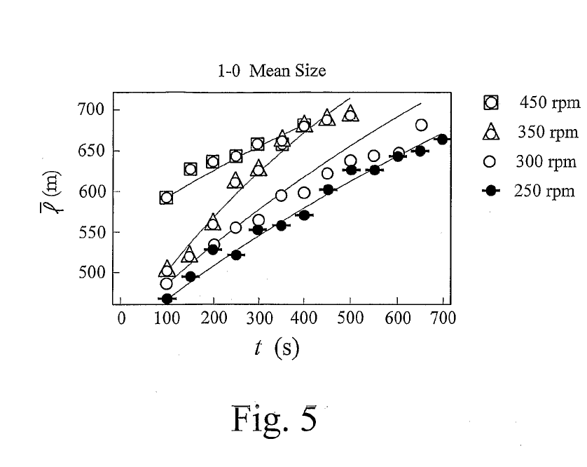

FIG. 5 is a graph of mean particle size against time for different impeller speeds in a mixer, as measured using the system of the invention.

In the drawings, a high shear mixer 10 (such as a VG series mixer (Glatt, Germany) or a Fielder or Gral mixer (Niro Inc., USA) processes a sample 12. In operation, powder raw materials are charged into the mixer 10 and the powder materials are gradually agglomerated into the form of granules by spraying, or otherwise adding, binding liquid to the powder material, while simultaneously subjecting the mixture to fluidised motion by the circulating movement of an impeller plate 14 having blades 16.

The nature of the mixer 10 is that the powder charge develops a toroidal shape in which the individual particles are both rotating in the direction of the arrow A, in a circular motion around the axis of the impeller plate 14, while at the same time orbiting about the circular axis (represented by arrow A) in the direction of the arrows B.

The mixer 10 is closed with a transparent lid forming a window 18 that is provided with an aperture 20 through which the shaft 22 of a rotary drive 24 extends. On the end of the shaft 22 is disposed a sampler in the form of a disc 26 having a serrated cylindrical edge 28. The disc 26 rotates in the direction of the arrow C, contrary to the direction of rotation of the charge 12. The disc 26 and charge 12, not to mention the speed of rotation of the impeller 14, are arranged so that the disc 26 intersects the inside edge of the toroidal cloud 12 of particles. The degree of intersection is not fundamental. Indeed, the edge of the toroid is vague. With the rotation of the disc contrary to the rotation of the toroid 12, particles impacting the disc are deflected in a fan-like spread 30 internally of the toroid 12. The greater the degree of intersection of the disc 26 with the toroid 12, the more dense the fan 30 is. The speed of rotation of the disc also influences the density and velocity of the particles in the fan 30.

A laser light source 32 is disposed above the transparent lid 18 with the spread beam illuminating at least a field of view area 40 of the fan 30. A suitable laser source is an HSI Diode laser, sold by Oxford Lasers Limited, UK. An LS 10-10 copper vapour laser might also be suitable. The laser light may be transmitted through optic fibre bundles (not shown) to facilitate manipulation of the light source and its direction.

A camera 36 is focussed on the zone 40 and, when the laser 32 is fired, captures an image such as that shown in FIG. 4a. Because the fan 30 is relatively thin, and deflected away from the main toroid flow 12, the base of the mixer 10, including the impeller 14, forms the background to each particle in the fan. Consequently, it is relatively dark compared with the laser-illuminated particles and the contrast between the particles and their background is high. It is ensured, of course, that the laser does not illuminate also the background field of the camera. Moreover, most of the particles deflected by the disc 26 in the fan 30 are in a single plane, at least in the region of the field of view 40. The camera and light source could be integrated in a probe (not shown) which may penetrate the wall of the mixer 10. In this event, the transparent window 18 is not absolutely necessary. A suitable probe is as described in U.S. Pat. No. 5,497,232, for example. The laser may be stroboscopic, and its illumination coordinated with opening of the camera aperture.

The camera 36 may form part of a particle shape characterisation system including a computer 38. The VisiSizer, produced by Oxford Lasers, UK, is an example. The software provided with such apparatus is capable of manipulating and analysing images. For example, it “thresholds” the image of FIG. 4a and inverts it in FIG. 4b. Then the individual shape and size of identified particles is defined, as in FIG. 4c. The software is capable of counting the particles and tabulating their size distribution, as well as their individual morphological parameters.

Depending on the computer speed, many hundreds of photographs can be taken. For example, 512 photos may be taken at 125 Hertz, which, again, depending on the density of the fan 30, may result in some 10,000 granules being analysed for their size. This photographic process takes about 4 seconds, although saving the photos to computer disc may take a further 15 seconds. Nevertheless the processing time to establish the particle size distribution is substantially instantaneous.

The field of view 40 is a function of the camera, and is perpendicular to the axis of the camera. From FIGS. 1 and 2, the field of view can be seen to be substantially parallel the disc 26. On the other hand, it is not precisely parallel, but slight misalignment as shown makes little difference to the functioning of the arrangement.

### EXAMPLE

An experiment to find the aggregation rate constant of granules made of lactose (M200, DMV, The Netherlands), starch (pharma quality, AVEBE, The Netherlands) and hydroxyl propyl cellulose (HPC, Klucel EP, Aqualon/Hercules, Barentz, Hoofddorp, The Netherlands) in water solution. The mixture was added in a 10 1 Roto Junior high shear mixer with the following formulation.

| Compound | Mass/Grams | Percentage of Dry Mass |
|---|---|---|
| Starch | 300 | 15 |
| Lactose | 1700 | 32 |
| HPC | 60 | 3 |
| Water | 350 | 17 |

The granulation process was followed in time by taking 512 photos every minute to obtain granule size distributions. About 10 to 20 granules were on each photo (see FIG. 4a), so that the granule size distribution for every minute is based on about 5000 to 10,000 granules. The photographs have a magnification such that granules in the size range 80 to 4000 micron are visible (480 pixels). The experiment was repeated at four different impeller speeds of 250, 300, 350 and 450 RPM. The results of the size distribution are shown in FIG. 5. From this, it can be seen that particle size increases with increasing impeller speed, as well as with time. Using the model developed by Hounslow et al^{[3]}, the experimental data was compared against the model and good agreement between the two was established.

Thus the disc 26 is extracting a representative sample of the particles in the toroid 12 and enabling the size distribution of the toroid 12 to be analysed. Isolating a small sample, and positioning the sample against a region of the mixer that provides a contrasting background, enables accurate monitoring of the size distribution of the particles in the mixing process.

While the present invention has been described in the context of a pilot-sized mixer, there is no reason why it may not be upgraded to larger size mixers. Moreover, with faster capture rates than can be achieved with personal computers, real-time, continuous particle size and size distribution monitoring can be achieved, whereby the peak (or desired end point) of particle aggregation in any given process can be established.

Finally, while the invention has been described in relation to toroidal flow mixers, there is no reason why it cannot be employed in other particle flow streams, such as along conduits (and in this respect the term “container” as used herein should be read as including, inter alia, conduits). In this scenario, the sampler of the invention deflects a proportion of the flow into a region of the conduit separate from the main flow. Provided the population of particles hitting the sampler are representative of the entire population, (which, perhaps surprisingly, is found to be the case at the inside edge of the toroidal flow of a mixer), then the size distribution of the entire flow can be determined.

While particle size is of primary interest, the system can also be employed to monitor composition, in particular moisture content, as well as colour of the sample. For this at least two wavelengths of light need to be monitored so that differential reflection/absorption of two or more wavelengths indicates moisture content:or colour change

### REFERENCES

[1] C F W Sanders, A W Willemse, A D Salman, M J Hounslow, Development of a predictive high shear granulation model, Powder Technology, 138 (2003) 18-24.

[2] S Watano, K Miyamami, Image processing for online monitoring of granule size distribution and shape in fluidised bed granulation, Powder Technology, 83 (1995) 55-60.

[3] M J Hounslow, R L Ryall, V R Marshall, A discretised population balance for nucleation, growth and aggregation, AIChE Journal 34 (1988) 1821-1832.

1. An optical on-line sizing system for a flow path of particles comprising:
an optical scanning system focussed on a field of view remote from said flow path;
a deflector to extract a representative sample of the particles from the flow path and distribute them in said field of view and whereby the size and size distribution of the particles in the flow path may be monitored; wherein
said deflector comprises a rotating disc disposed in said flow path and lying substantially in the plane of said field of view so that particles impacting the surface of the disc are deflected from said flow path into said field of view at different angles.

2. A system as claimed in claim 1, in which said flow path is in a container provided with a window, said optical scanning system being outside said container.

3. A system as claimed in claim 2, in which said container is a high shear mixer.

4. A system as claimed in claim 1, in which the edge of the disc is cylindrical.

5. A system as claimed in claim 4, in which said disc is circular cylindrical.

6. A system as claimed in claim 4, in which the surface of the edge of the disc is serrated to improve frictional engagement with particles impacting the edge.

7. A system as claimed in claim 1, in which a top face of the disc is substantially planar and horizontal.

8. A system as claimed in claim 7, in which said top face is serrated to improve grip on particles landing on said face and being thrown from said face by centrifugal effects.

9. A system as claimed in claim 1, further comprising a laser illuminating said field of view.

10. A system as claimed in claim 1, further comprising composition scanning means.

11. A system as claimed in claim 10, in which scanning means comprises a spectrometer.

12. A system as claimed in claim 10, in which said composition scanning means detects moisture content and/or colour.

13. A system as claimed in claim 12, in which scanning means comprises a camera responsive to two different wavelengths, one of which is preferentially absorbed or reflected by moisture-containing particles.

14. A system as claimed in claim 1, in which said optical scanning system comprises a digital camera connected to a computer, whereby images of the field of view may be processed by the computer to count and size particles captured by said images.

15. A system as claimed in claim 1 employed in the preparation of pharmaceutical compositions for subsequent tabletting or encapsulation.

16. A high shear mixer and particle size system, comprising:
a) a mixer having:
i) a substantially cylindrical housing,
ii) an impeller, mounted in the housing, which impeller, when driven, and when particles of mixture are sheared by the impeller, drives the particles in a toroidal flow path around the housing,
iii) a rotary shaft extending through the housing,
iv) a disc mounted on the end of the shaft so that the edge of the disc intercepts an inside edge of said toroidal flow path;
b) an optical scanner focussed on a field of view in a plane substantially parallel to said disc between said toroidal flow path and the axis of the impeller; and
c) processing means to capture images of particle samples in said field of view deflected by said disc from said toroidal flow path and count and/or measure and/or determine the shape of said particles.

17. A mixer and system as claimed in claim 16, in which said impeller is mounted in the base of said mixer.

18. A mixer and system as claimed in claim 16, in which said shaft is substantially parallel to said axis of the impeller.

19. A mixer and system as claimed in claim 16, in which up to half the disc intercepts the flow path.

20. A mixer and system as claimed in claim 16, further comprising light projecting means.

21. A mixer and system as claimed in claim 20, in which said light projecting means comprises a bundle of optical fibers.

22. A mixer and system as claimed in claim 20, in which the light projecting means comprises a stroboscope.

23. A mixer and system as claimed in claim 20, in which said light projecting means and optical scanner means are affixed together as parts of a unitary photographic probe.

24. A mixer and system as claimed in claim 16, further comprising a window in the housing, said scanner being entirely external of the mixer.

25. A mixer and system as claimed in claim 23, in which said window is in a top surface of the mixer.

26. A mixer and system as claimed in claim 20, further comprising control means for actuating the light projecting means and the optical scanner in timed synchronism with one another.

27. A mixer and system as claimed in claim 16 employed in the preparation of pharmaceutical compositions for subsequent tabletting or encapsulation.
